(19) United States
(12) Patent Application Publication
(10) Pub. No.: US 2004/0089150 A1
(43) Pub. Date: May 13, 2004

(54) Piston for an internal combustion engine

(76) Inventor: Eberhard Bubeck, Fellbach (DE)

Correspondence Address: WILLIAM COLLARD, COLLARD & ROE, P.C., 1077 NORTHERN BOULEVARD, ROSLYN, NY, 11576, US

(21) Appl. No.: 10/343,727

(22) PCT Filed: Jul. 20, 2001
(86) PCT No.: PCT/DE01/02833

(30) Foreign Application Priority Data
Aug. 3, 2000 (DE) 100 37 887.0

(51) Int. Cl. F16J 1/04

(52) U.S. Cl. 92/216

(57) ABSTRACT

The invention relates to a piston comprising a shaft or supporting ring which rests directly on the hubs. The aim of the invention is to fix the latter on the hubs as simply as possible. To this end, the supporting ring is fixed on the hubs with a bayonet-type joint.

The invention relates to a piston for an internal combustion engine according to the introductory part of claim 1.

Such a piston is known from DE 19 54 7157 A. Various possibilities are disclosed there for securing the supporting ring on the hubs, for example by screwing it on, shrinking it on, welding.

Shrinking and welding it on might possibly cause distortion in the area of the hub; when it is screwed on, the threads have to be positioned with high accuracy in order to avoid distortion. Furthermore, cutting threads into the materials commonly used for pistons is connected with considerable expenditure.

The invention therefore deals with the problem of finding in connection with pistons of this type a possibility for securing the shaft or the supporting ring in a manner that will not lead to distortion in the area of the hub, and that can be produced in a simple manner.

This problem is resolved by the characterizing feature of claim 1. Advantageous further developments are the objects of the dependent claims.

If the supporting ring is secured in the manner of a bayonet-type joint, a centric positioning in relation to the hub is obtained. The joint is largely free of stress and can be released.

In the present context, the term “bayonet lock” means that after the shaft or the supporting ring has been slipped over the hubs in the axial direction and rotated in the peripheral direction, it is brought into a position in which either inwardly pointing protrusions of the shaft engage grooves in the hubs, or protrusions on the hubs engage grooves in the shaft. The shaft is secured in this manner against axial displacement.

The supporting ring or the shaft is installed on the hubs by pushing it, in a position in which the hubs and the areas with the larger inside diameter on the supporting ring are aligned, up to the level of the grooves extending on the outer surfaces of the hubs in the peripheral direction, and by subsequently rotating it—in connection with an embodiment according to FIG. 2—by about 30°, so that the areas of the supporting ring having a smaller inside diameter will engage the grooves extending in the peripheral direction. The supporting ring or the shaft can be subsequently secured against rotation in the peripheral direction by one or more clamping sleeves.

It is basically possible that the four grooves in the hubs each have a different diameter on the base of the groove. However, it is more favorable in terms of manufacturing technology if the diameter of the base of the groove is constant in all four grooves.

The invention is explained in greater detail in the following with the help of a drawing, in which:

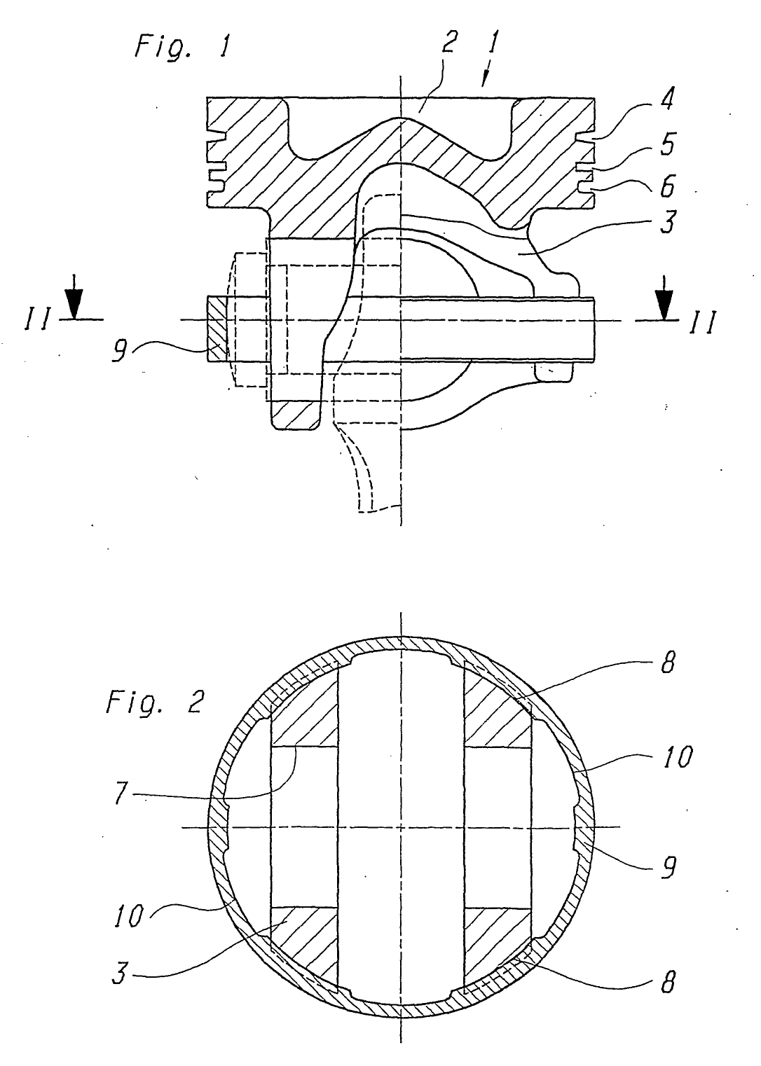

FIG. 1 is a side view of a piston with a supporting ring; and

FIG. 2 is a cross section at the level of the axis of the hub.

A piston 1 consists of a piston head 2 made of forged steel, the hubs 3 that are starting from the head of the piston, and the annular grooves 4, 5 and 6 that are radially grooved into the piston head for receiving a piston pin in each case. In the peripheral direction of the piston, a groove 8 is grooved into the hubs at the level of the axis of the pin with interruptions, whereby the groove is extending over only a few degrees of angle, about 15 to 30 degrees per grooved outer surface of the hub in accordance with the dashed areas in FIG. 2.

Each of the two hubs is grooved on the pressure and the counter pressure sides, so that the groove or grooves comprise an angular area of about 60 to 120 degrees, added up over all four surfaces. A supporting ring 9 is resting in the groove or grooves directly on the hubs in the manner of a bayonet-type joint.

FIG. 2 shows that the supporting ring 9 has different inside diameters, whereby the larger inside diameter present in the area of the recesses 10 is dimensioned in such a way that the supporting ring 9 can be slipped over the hubs 3 from the bottom, and that the smaller inside diameter will approximately correspond with the diameter of the base of the grooves extending in the hubs.

In FIG. 2, the supporting ring 9 is mounted turned by about 30°. Other angles of rotation are possible. The height of the groove 9 approximately corresponds with the height of the supporting ring 9, whereby the axial play between the groove and the supporting ring is dimensioned in the normal case in such a way that the supporting ring 9 can be rotated in the groove by hand.

1. A piston for an internal combustion engine with a supporting ring (9) or a piston shaft mounted on the hubs of the piston in a detachable manner, characterized in that the piston shaft or the supporting ring is connected with the hubs of the piston in the manner of a bayonet-type joint.

2. The piston for an internal combustion engine according to claim 1, characterized in that the supporting ring ((9) or the shaft is joined with the hubs by slipping it over the hubs (3) in the direction of the longitudinal axis of the piston and subsequently rotating it into a position with undercutting in a groove with interruptions in the peripheral direction (8) or in the grooves (8).

3. The piston according to claim 1, characterized in that the hubs (3) each have grooves (8) extending on the pressure and counter-pressure sides at about the same level in the peripheral direction; that the supporting ring (9) or the shaft has different diameters, whereby one inside diameter approximately corresponds in each case with the diameter of the base of the grooves (8), and one diameter is adequately large in each case for slipping the supporting ring (9) over the hubs (3) up to the level of the grooves (8) extending in the peripheral direction.

4. The piston-cylinder construction unit according to claim 2 or 3, characterized in that the levels of the areas of the hubs and the supporting ring or shaft engaging one another are coordinated with each other in such a manner that a fit with play is obtained between the two in the mounted condition.

5. The piston-cylinder construction unit according to any one of the preceding claims, characterized in that the supporting ring (9) or shaft is secured against rotation by a safety pin or a clamping pin.
